(19) United States
(12) Patent Application Publication
(10) Pub. No.: US 2026/0001505 A1
(43) Pub. Date: Jan. 1, 2026

(54) BOLSTER

(71) Applicant: TACHI-S CO., LTD., Tokyo (JP)

(72) Inventors: Ryuuichi Harashima, Ome-shi (JP); Takahiko Suzuki, Ome-shi (JP); Kouichi Moroi, Ome-shi (JP); Jyunichi Utsumi, Ome-shi (JP)

(73) Assignee: TACHI-S CO., LTD., Tokyo (JP)

(21) Appl. No.: 19/249,319

(22) Filed: Jun. 25, 2025

(30) Foreign Application Priority Data
Jun. 27, 2024 (JP) 2024-104381

(51) Int. Cl. B60R 21/207; B60N 2/64; B60R 21/215

(52) U.S. Cl. CPC B60R 21/207; B60N 2/643; B60R 21/215

(57) ABSTRACT

To provide a bolster, the versatility of which can be improved. A bolster has an upper part formed by covering a pad by a bag portion composed of a skin member and a skin piece. Consequently, even when a back surface of the bolster protrudes from a side wall of a car compartment, the pad, a bracket, and the like can be made less likely to be exposed to a car interior as long as the protrusion is within the range of the provided skin piece. Therefore, the shape of the bolster within the range of the provided skin piece does not have to match the shape of the side wall, whereby the versatility of the bolster can be improved.

### BACKGROUND OF THE INVENTION

### 1. Field of the Invention

The present invention relates to a bolster configured to be provided to a side part of a seat back of a car seat, and in particular, relates to a bolster, the versatility of which can be improved.

### 2. Description of the Related Art

A car seat including a seat back having a side part provided with a bolster has been known. The bolster forms a part of a backrest together with the seat back and supports a side part of the upper half of the body of an occupant seated on the car seat. A bolster described in Japanese Patent Application Laid-Open (kokai) No. 2020-142662 includes: a pad formed of foam; a bracket covering substantially the entirety of a back surface of the pad and configured to be fixed to a side wall of a car compartment, the bracket being formed of a resin plate; and a skin member covering a front surface and the like of the pad and having a peripheral edge hooked on the bracket. Conventionally, the shape, on a car interior side, of the bolster is set to match the shape of the side wall at the position of the fixation such that the bracket, the pad, and the like are hardly exposed from a back surface of the bolster to the car interior, i.e., such that the bolster hardly protrudes from the side wall at said position to the car interior side in a leftward-rightward direction.

### SUMMARY OF THE INVENTION

However, the above conventional technology has a problem in that the shape of the bolster needs to be changed each time the shape of the side wall is changed, and thus the versatility of the bolster is low.

The present invention has been made to solve the above problem, and an object of the present invention is to provide a bolster, the versatility of which can be improved.

In order to achieve the object, a bolster according to the present invention is a bolster configured to be provided to a side part of a seat back forming a backrest, the bolster being configured to be fixed to a side wall of a car compartment, the bolster including: a pad formed of foam; a bracket fixed to a back surface of the pad and configured to be attached to the side wall; a skin member fixed to at least one of the pad and the bracket so as to cover a front surface, an upper surface, and both side surfaces of the pad; and a skin piece connected to an upper edge and both side edges on a back side of the skin member so as to cover a part of an upper side of the back surface of the pad.

The bolster according to the first aspect has an upper part formed by covering the pad by a bag portion composed of the skin member and the skin piece. Consequently, even when a back surface of the bolster protrudes from the side wall of the car compartment to a car interior side in a leftward-rightward direction, the pad, the bracket, and the like can be made less likely to be exposed to the car interior as long as the protrusion is within the range of the provided skin piece. Therefore, the shape of the bolster within the range of the provided skin piece does not have to match the shape of the side wall, whereby the versatility of the bolster can be improved.

A bolster according to a second aspect exhibits the following advantageous effect in addition to the advantageous effect exhibited by the bolster according to the first aspect. The skin piece is detachably connected to at least parts of the upper edge and both side edges of the skin member such that the back surface of the pad covered by the skin piece can be exposed. After the pad is covered by the skin member in a state where a detachable portion of the skin piece is detached, the detachable portion of the skin piece is connected to the skin member, whereby work for attaching the bag portion to the pad can be easily performed.

A bolster according to a third aspect exhibits the following advantageous effect in addition to the advantageous effect exhibited by the bolster according to the second aspect. The skin piece is detachably connected to the at least parts of the upper edge and both side edges of the skin member by using a zipper. In the case of the zipper, the connection can be further inhibited from being unintentionally undone than in a case where, for example, these constituents are detachably connected by using a hook-and-loop fastener.

A bolster according to a fourth aspect exhibits the following advantageous effects in addition to the advantageous effect exhibited by the bolster according to the second aspect. The skin member is fixed to a part, of the back surface of the pad or the bracket, that is present at such a position as to be covered by the skin piece. When the skin member is fixed to the pad or the bracket at the position, it can be made less likely for a wrinkle or the like to be formed on the skin member at a part thereof near the skin piece, whereby a beautiful appearance of the skin member can be ensured. Furthermore, by detaching the detachable portion of the skin piece, the skin member can be easily fixed to the part, of the pad or the like, that is present at such a position as to be covered by the skin piece.

A bolster according to a fifth aspect exhibits the following advantageous effects in addition to the advantageous effect exhibited by the bolster according to the second aspect. An air bag is accommodated in a recess formed in the back surface of the pad and is attached to the bracket. Parts of the recess and the air bag are each present at such a position as to be covered by the skin piece. Even though the air bag is located at the position, detachment of the detachable portion of the skin piece at the time of assembling the bolster in which the air bag is accommodated in the recess can make it less likely for the air bag and the skin piece to interfere with each other and can make it easy to fix the air bag to the bracket at such a position as to be covered by the skin piece.

A bolster according to a sixth aspect exhibits the following advantageous effect in addition to the advantageous effects exhibited by the bolster according to the fifth aspect. A reinforcement sheet having a higher rigidity than the skin piece is attached to a surface on the pad side of the skin piece so as to straddle the recess. Consequently, the skin piece can be inhibited from being warped toward the recess, and a wrinkle can be inhibited from being formed on the skin piece, whereby a beautiful appearance of the skin piece exposed to the car interior can be ensured.

A bolster according to a seventh aspect exhibits the following advantageous effects in addition to the advantageous effect exhibited by the bolster according to the first aspect. The pad has a frame that is formed of a metal and that is embedded along the back surface of the pad so as to enclose the recess. The skin member is attached to the frame via a plurality of fixation tools that are away from each other, so as to enclose the recess, whereby the skin member is fixed to the back surface of the pad. These features make it possible to ensure the rigidity of the pad and easily fix the skin member to the pad even in the absence of, for example, the conventional resin plate which covers the entirety of the back surface of the pad and on which the skin member is hooked.

Furthermore, the bolster further includes an air bag accommodated in a recess formed in the back surface of the pad. The bracket is a member that is formed of a metal and that is fixed to the back surface of the pad by being attached to the frame so as to straddle the recess, and the air bag is attached to the bracket. Here, it is difficult to design the rigidity of the conventional resin plate such that the conventional resin plate withstands a force exerted upon deployment of the air bag. Meanwhile, since the bracket and the frame to which the bracket is attached and which is embedded in the pad so as to enclose the recess are each formed of a metal, it can be made easier to design the rigidities of the bracket and the frame against a force exerted upon deployment of the air bag than in a case where a member formed of a resin is used.

A bolster according to an eighth aspect exhibits the following advantageous effect in addition to the advantageous effect exhibited by the bolster according to the first aspect. The skin piece is formed of a carpet material. Thus, the tactile quality or the like of the skin piece exposed to the car interior can be enhanced.

### BRIEF DESCRIPTION OF THE DRAWINGS

FIG. 1 is a perspective view of a car seat provided with a bolster according to an embodiment.

FIG. 2 is a back view of a seat back and the bolster.

FIG. 3 is a exploded perspective view of the bolster.

FIG. 4A is a back view of the bolster.

FIG. 4B is a back view of the bolster in a state where a connection made by using a zipper is undone.

FIG. 5 is a cross-sectional end view, of the bolster, taken at a line V-V in FIG. 4A.

FIG. 6 is a Cross-sectional end view, of the bolster, taken at a line VI-VI in FIG. 4A.

### DESCRIPTION OF THE PREFERRED EMBODIMENTS

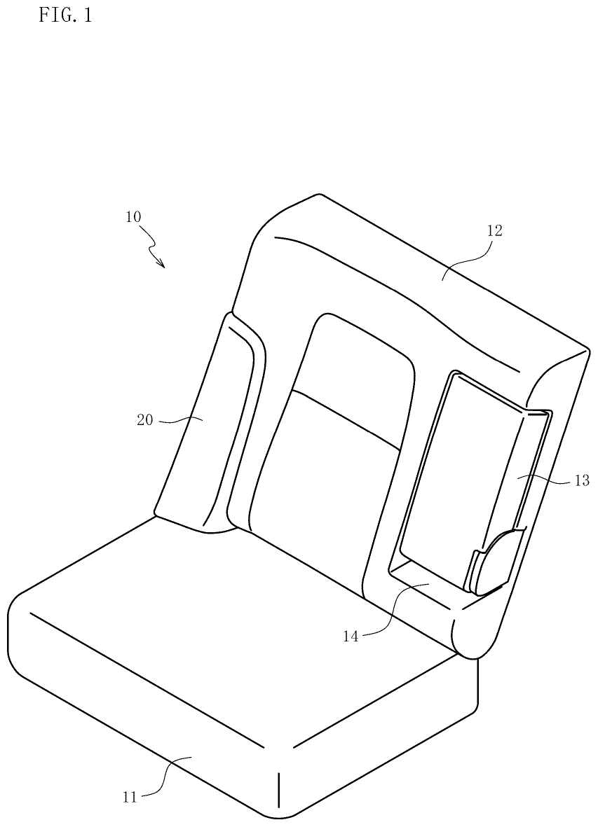

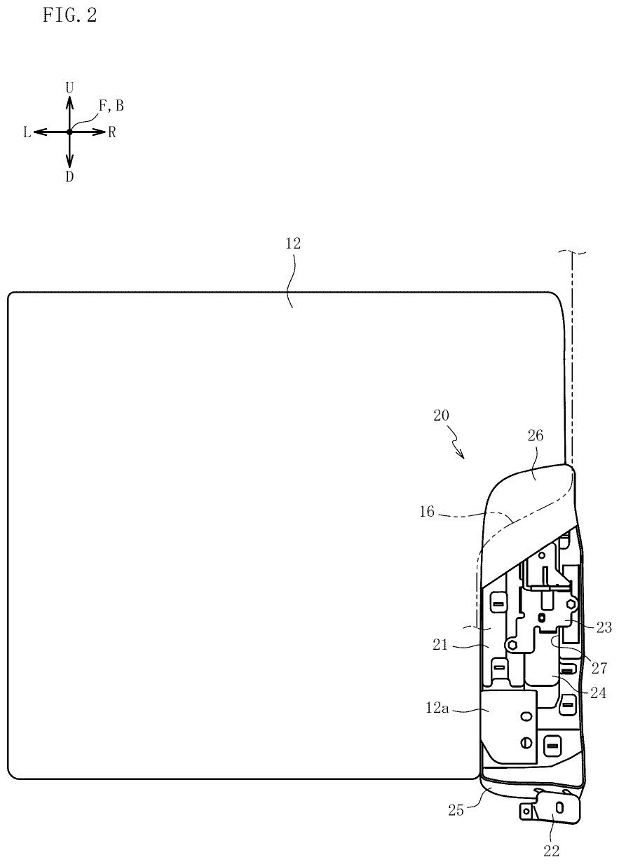

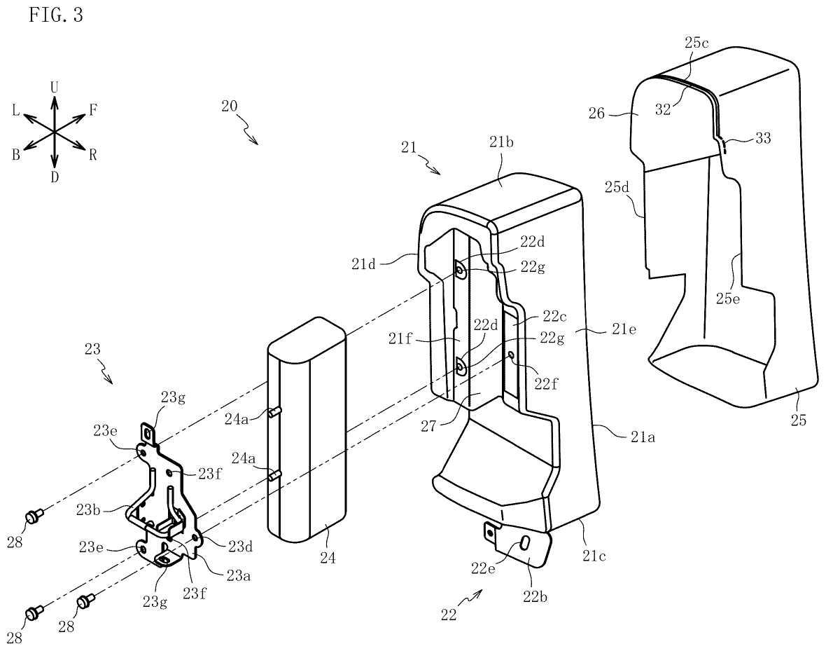

Hereinafter, a preferred embodiment of the present invention will be described with reference to the accompanying drawings. FIG. 1 is a perspective view of a car seat 10 provided with a bolster 20 according to an embodiment. FIG. 2 is a back view of a seat back 12 and the bolster 20. In FIG. 2, the direction of an arrow U, the direction of an arrow D, the direction of an arrow L, the direction of an arrow R, the direction of an arrow F, and the direction of an arrow B respectively indicate an upward direction, a downward direction, a leftward direction, a rightward direction, a frontward direction, and a backward direction of the seat back 12 and the bolster 20 (the same applies to FIG. 3 to FIG. 6). These directions are identical to respective directions as seen from a person seated on the car seat 10 in a state where the seat back 12 is vertically raised.

The car seat 10 is a seat mounted in a car (e.g., an automobile). The car seat 10 mainly includes: a seat cushion 11 forming a seating surface; the seat back 12 which forms a backrest and which has a lower end part rotatably supported on the seat cushion 11; an armrest 13 which is capable of forming a rest for an arm and which has a proximal end part rotatably supported on the seat back 12; and the bolster 20 provided to a side part of the seat back 12.

The seat cushion 11 is formed by: supporting, on a cushion frame (not shown) formed of a metal or a synthetic resin, a cushion pad (not shown) formed of foam such as soft polyurethane foam; and covering the cushion pad by a skin material (not shown). The seat cushion 11 in the present embodiment forms seating surfaces, for two persons, of a back seat of the car.

Likewise, the seat back 12 is formed by: supporting, on a back frame (not shown) formed of a metal or a synthetic resin, a back pad (not shown) formed of foam such as soft polyurethane foam; and covering the back pad by a skin material (not shown).

The seat back 12 in the present embodiment can form backrests, for two persons, of the back seat of the car. Out of the backrests for two persons, the backrest on the left side is partially formed by the armrest 13 in an accommodated state. The accommodated state is a state where: the armrest 13 which is rotatable is raised; and the armrest 13 is accommodated in an accommodation recess 14 formed in a front surface of the seat back 12.

Meanwhile, a state where the armrest 13 is tilted so as to be substantially parallel to the seat cushion 11 is an in-use state of the armrest 13. On the armrest 13 in the in-use state, an arm of a person seated on the right side on the car seat 10 and an arm of a person seated on a seat separately provided on the left side relative to the car seat 10 can be placed.

The bolster 20 forms a part of a backrest together with the seat back 12. The bolster 20 according to the present embodiment is provided to a right side part of the seat back 12 and supports a right side part of the upper half of the body of an occupant seated on the right side of the car seat 10. The seat back 12 is in contact with an upper surface and a left side surface of the bolster 20.

In FIG. 2, a side wall 16 is indicated by an alternate long and two short dashes line. The side wall 16 is a part of the car body and is located on the right side of a car compartment which is an inner space of the car. The space on the left side relative to the side wall 16 is the car compartment, and the space on the right side relative to the side wall 16 is the inside of the car body. The side wall 16 at a part thereof on the back side relative to the seat back 12 has an upper side and a lower side that is bulged, relative to the upper side, to the car interior side in such a manner as to avoid a wheel. The bolster 20 has a back surface fixed to the bulged portion of the side wall 16.

On the back surface side relative to a lower part of the bolster 20, a rotary support mechanism 12a for rotatably supporting the seat back 12 partially protrudes rightward from the seat back 12 and is fixed to the side wall 16. When the seat back 12 is tilted frontward from the state shown in FIG. 1 by the rotary support mechanism 12a, the seat back 12 is separated from the bolster 20 so that a state where only the bolster 20 stands on the seat cushion 11 is obtained.

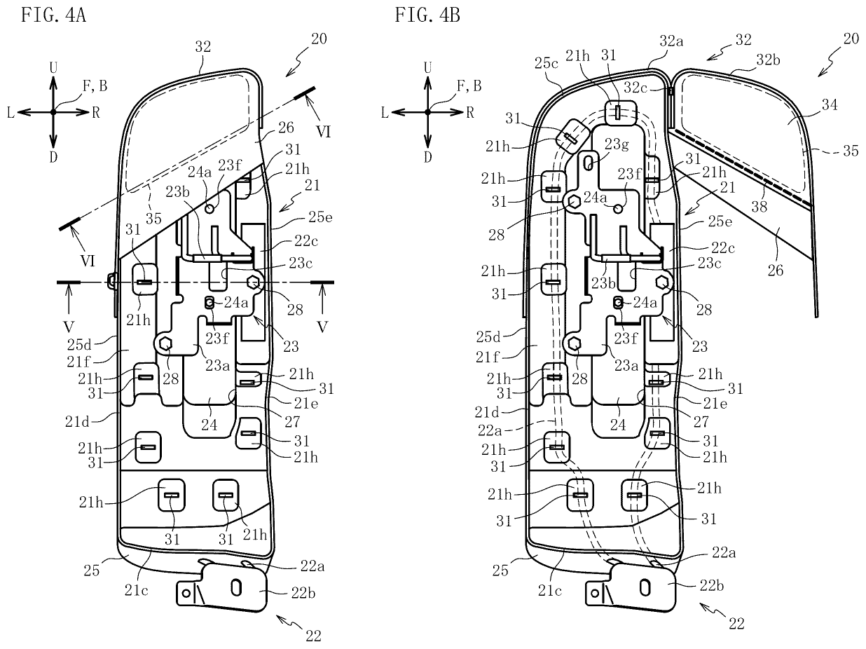

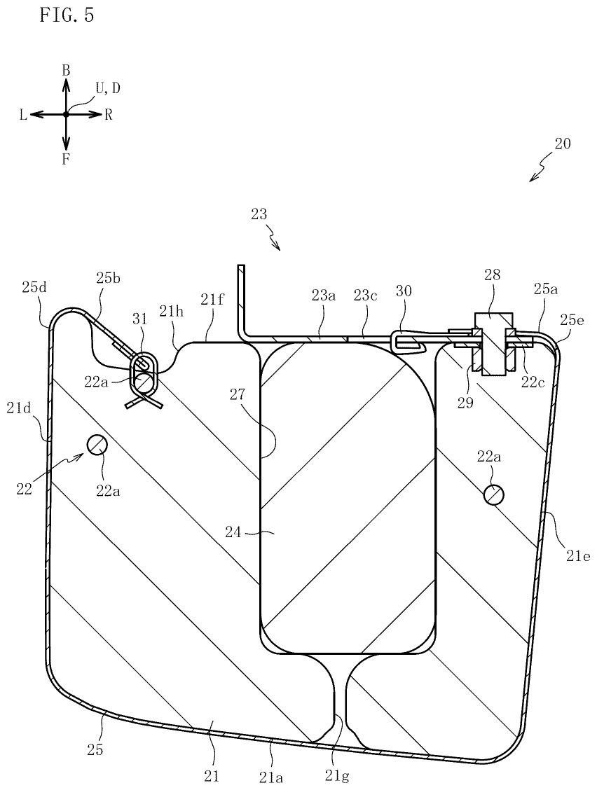

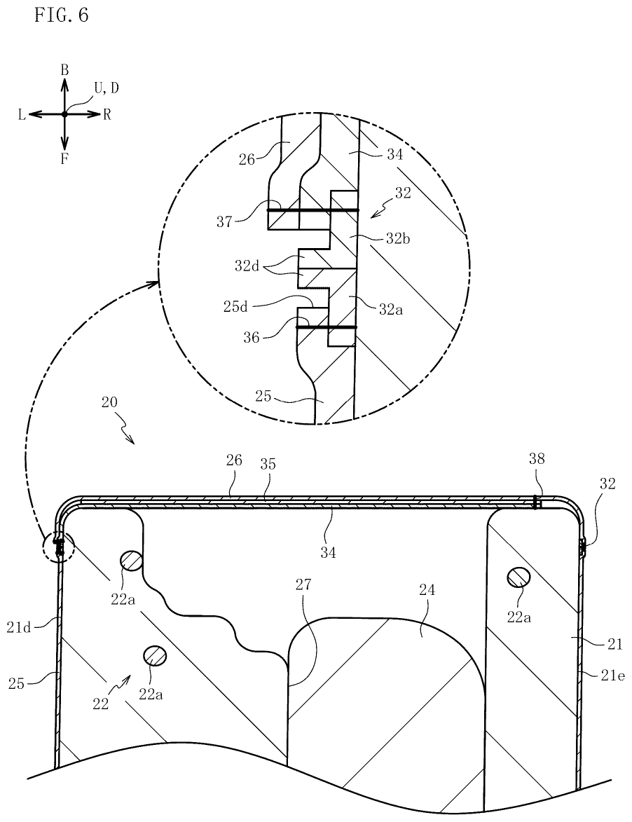

Next, the bolster 20 will be described in detail with reference to FIG. 3 to FIG. 6. FIG. 3 is an exploded perspective view of the bolster 20. FIG. 4A is a back view of the bolster 20. FIG. 4B is a back view of the bolster 20 in a state where, unlike in FIG. 4A, a connection made by using a zipper 32 is undone and a skin piece 26 is opened rightward. FIG. 5 is a cross-sectional end view, of the bolster 20, taken at a line V-V in FIG. 4A. FIG. 6 is a cross-sectional end view, of the bolster 20, taken at a line VI-VI in FIG. 4A. FIG. 3 does not show exposure recesses 21h, attachment piece portions 25a and 25b, an attachment tool 30, fixation tools 31, or the like described later, and FIG. 4A and FIG. 4B do not show the attachment piece portions 25a and 25b, the attachment tool 30, or the like. FIG. 5 shows the attachment piece portion 25a and the attachment tool 30 located on the farther side on the drawing sheet relative to the cross-sectional end.

As shown in FIG. 3 and FIG. 5, the bolster 20 includes: a pad 21 formed of foam such as soft polyurethane foam; a frame 22 formed of a metal and embedded in the pad 21; a bracket 23 formed of a metal and configured to connect the frame 22 to the side wall 16 (see FIG. 2); an air bag 24 accommodated in a recess 27 formed in a back surface 21f of the pad 21; a skin member 25 covering the pad 21 excluding the back surface 21f thereof; and the skin piece 26 covering a part of an upper side of the back surface 21f of the pad 21.

The pad 21 has a front surface 21a, an upper surface 21b, a lower surface 21c, a left side surface 21d, a right side surface 21e, and the back surface 21f and is formed in the shape of a substantially rectangular parallelepiped. The shape of the back surface 21f is set to match the shapes of the side wall 16 and the rotary support mechanism 12a (see FIG. 2) opposed to the back surface 21f in the frontward-backward direction.

Furthermore, the back surface 21f has a center at which the recess 27 obtained through recession toward the front surface 21a side is formed so as to extend in the upward-downward direction. The pad 21 has a slit 21g which is formed in a penetrating manner and which is opened in each of a bottom surface defining the recess 27 and the front surface 21a. The slit 21g is provided at the center in the leftward-rightward direction of the bottom surface defining the recess 27 and extends in the upward-downward direction.

The frame 22 includes: a wire 22a embedded in the pad 21 along the back surface 21f and having the shape of a round rod; and a plurality of attachment plates 22b, 22c, and 22d joined to the wire 22a through welding or the like. The wire 22a is disposed in an annular pattern so as to enclose the recess 27 (see FIG. 4B). The wire 22a in an annular pattern may be, at a part or the entirety thereof in the circumferential direction, wound one turn or wound two or more turns.

The attachment plate 22b is a portion protruding downward from the lower surface 21c of the pad 21 and has a through-hole 22e which is formed in a penetrating manner and which is for attachment to the car body or the seat cushion 11 by using a bolt or the like. The attachment plate 22c is a portion located on the right side relative to the recess 27 and on substantially the same plane as that of the back surface 21f and has a through-hole 22f formed in a penetrating manner. The attachment plate 22d is a portion located on the left side relative to the recess 27 and on substantially the same plane as that of the back surface 21f and has a through-hole 22g formed in a penetrating manner. Two said attachment plates 22d are provided such that the respective through-holes 22g are located on both upper and lower sides with the through-hole 22f therebetween.

The bracket 23 includes: a plate portion 23a superposed on the back surface 21f of the pad 21 so as to straddle the recess 27; and a mounting portion 23b joined to the plate portion 23a through welding or the like. The plate portion 23a is a plate material having a smaller dimension in the upward-downward direction than the recess 27 and is superposed also on back surfaces of the attachment plates 22c and 22d. The plate portion 23a has a center at which a hooking hole 23c having a quadrangular shape is formed in a penetrating manner.

The plate portion 23a has an attachment hole 23d and two attachment holes 23e which are formed in a penetrating manner. The attachment hole 23d is in communication with the through-hole 22f in a state of where the plate portion 23a is superposed on the attachment plates 22c and 22d. The attachment holes 23e are in communication with the two respective through-holes 22g in said state. Bolts 28 inserted into the respective attachment holes 23d and 23e and the respective through-holes 22f and 22g are fitted to nuts 29 joined in advance to front surfaces (surfaces on the pad 21 side) of the attachment plates 22c and 22d, whereby the bracket 23 is attached to the frame 22. Consequently, the bracket 23 is fixed to the back surface 21f of the pad 21 in which the frame 22 has been embedded.

The mounting portion 23b is an annular portion that protrudes backward from the plate portion 23a and that is attached to the side wall 16 (see FIG. 2). By attaching the bracket 23 to the side wall 16 in this manner, the back surface of the bolster 20 is fixed to the side wall 16.

The air bag 24 is for protecting the seated person by entering a deployed state as a result of bulging a built-in bag thereof when a strong impact is applied to the car. Upon deployment of the air bag 24, the bag having burst out frontward from the slit 21g breaks through a joint of the skin member 25 provided along the slit 21g and is bulged on a front surface of the bolster 20. The air bag 24 has a back part supported by the bracket 23 so as to be able to withstand a force generated backward upon this deployment.

Two screw shanks 24a protrude backward from the back part of the air bag 24. These two screw shanks 24a are inserted into two respective insertion holes 23f formed in a penetrating manner in the plate portion 23a of the bracket 23. Nuts (not shown) are fitted to the inserted screw shanks 24a, whereby the air bag 24 is attached to the bracket 23. A wire (not shown) extending from the air bag 24 is inserted via a clip or the like into mounting holes 23g provided in an upper part and a lower part of the plate portion 23a.

The skin member 25 is a member forming an outer surface of the bolster 20 and is formed by sewing a plurality of materials such as fabric, synthetic leather, and leather. The skin member 25 does not cover the back surface 21f of the pad 21 and covers the front surface 21a, the upper surface 21b, the lower surface 21c, the left side surface 21d, and the right side surface 21e of the pad 21.

A plurality of attachment piece portions 25a and 25b protrude from peripheral edges (an upper edge 25c, a left edge 25d, a right edge 25e, and a lower edge) on the back side of the skin member 25 toward the center in the leftward-rightward direction or the upward-downward direction of the bolster 20. The attachment piece portions 25a and 25b are integrally formed with the skin member 25. Alternatively, the attachment piece portions 25a and 25b may be sewn to the peripheral edges of the skin member 25 and may be formed of materials such as fabric, synthetic leather, and leather that are different from the materials of the skin member 25.

The attachment piece portion 25a is a portion fixed to the bracket 23 via the attachment tool 30. The attachment tool 30 is a member having the shape of a hook and joined to an end of the attachment piece portion 25a through sewing, adhesion, or the like. The attachment tool 30 is hooked in the hooking hole 23c of the bracket 23, whereby the attachment piece portion 25a is fixed to the bracket 23.

The attachment piece portion 25b is a portion fixed to the back surface 21f of the pad 21 via a fixation tool 31 and has an end side folded back into two so as to be reinforced. The fixation tool 31 is a metal fitting called a hog ring and has substantially a U shape before the attachment piece portion 25b is fixed. At the time of the fixation, first, the fixation tool 31 having substantially a U shape is inserted into holes (not shown) formed in a penetrating manner in the attachment piece portion 25b, and the pad 21 is pierced by the fixation tool 31 such that the wire 22a enters the inner side of the fixation tool 31. Thereafter, the fixation tool 31 is bent into an annular shape by using a dedicated tool. Consequently, the attachment piece portion 25b is attached to the wire 22a via the fixation tool 31, and the attachment piece portion 25b is fixed to the pad 21 in which the wire 22a has been embedded.

In the back surface 21f at a part thereof to which the fixation tool 31 is attached, an exposure recess 21h obtained through recession toward the wire 22a is formed such that the wire 22a is exposed or seen through from the back surface 21f. In FIG. 4A and FIG. 4B, a plurality of the fixation tools 31 and a plurality of the exposure recesses 21h are arranged along the wire 22a so as to enclose the recess 27. FIG. 4A and FIG. 4B do not show a plurality of the attachment piece portions 25b. In actuality, however, a plurality of the attachment piece portions 25b extending from the peripheral edges of the skin member 25 are fixed to the back surface 21f of the pad 21 via the respective fixation tools 31 shown.

As described above, the frame 22 formed of a metal is embedded along the back surface 21f of the pad 21 so as to enclose the recess 27, and the skin member 25 is attached to the frame 22 via the plurality of fixation tools 31, whereby the skin member 25 is fixed to the pad 21. These features make it possible to ensure the rigidity of the pad 21 and easily fix the skin member 25 to the pad 21 even in the absence of, for example, the conventional resin plate which covers the entirety of the back surface 21f of the pad 21 and on which the skin member 25 is hooked.

Here, in a case where the air bag 24 is accommodated in the recess 27 of the pad 21, it is difficult to design the rigidity of the conventional resin plate such that the conventional resin plate withstands a force exerted upon deployment of the air bag 24. Meanwhile, in the present embodiment, a back surface of the air bag 24 is supported by: the frame 22 formed of a metal and embedded in the pad 21 so as to enclose the recess 27; and the bracket 23 formed of a metal and attached to the frame 22 so as to straddle the recess 27. Since the frame 22 and the bracket 23 are each formed of a metal in this manner, it can be made easier to design the rigidities of the frame 22 and the bracket 23 against a force exerted upon deployment of the air bag 24 than in a case where a member formed of a resin is used.

Basically, the skin member 25 is fixed to the back surface 21f (wire 22a) of the pad 21 via the plurality of fixation tools 31. Meanwhile, since the wire 22a is present on the reverse side (front side) of the attachment plate 22c, no fixation tool 31 can be attached to the wire 22a at a position, on the back surface 21f, at which the attachment plate 22c is provided. However, even at such a position, it can be made less likely for a wrinkle or the like to be formed on the skin member 25 at a part thereof near the attachment plate 22c by attaching the attachment tool 30 having the shape of a hook to the bracket 23.

As shown in FIG. 3 and FIG. 4A, the skin piece 26 is a cloth-like member connected to the entirety of the upper edge 25c, an upper part of the left edge 25d, and an upper part of the right edge 25e among the peripheral edges on the back side of the skin member 25. The skin piece 26 is formed of a carpet material. The carpet material is identical to a carpet material used for a floor surface of a luggage space of the car or a reverse surface of the seat back 12. Consequently, the skin piece 26 and the seat back 12 adjacent to each other can provide a sense of unity, and a beautiful appearance of the car seat 10 can be improved.

The skin piece 26 is detachably connected to the entirety of the upper edge 25c, the upper part of the left edge 25d, and an upper side of the upper part of the right edge 25e of the skin member 25 by using the zipper 32. Furthermore, the skin piece 26 is sewn to a lower side of the upper part of the right edge 25e of the skin member 25 by using a yarn 33. The zipper 32 is located on the upper surface 21b, the left side surface 21d, and the right side surface 21e of the pad 21 and is not located on the back surface 21f of the pad 21. Consequently, as shown in FIG. 2, the zipper 32 is hidden by the seat back 12 or the side wall 16 and can be made less visible from behind the seat back 12.

As shown in FIG. 4B and FIG. 6, the zipper 32 includes: tape 32a sewn to the peripheral edges of the skin member 25 by using a yarn 36; tape 32b sewn to peripheral edges of the skin piece 26 by using a yarn 37; and a slider 32c which is moved along the tapes 32a and 32b. The tapes 32a and 32b are provided with respective elements 32d which can be engaged with each other at the time of a connection. When the slider 32c is moved to the left edge 25d side, the elements 32d of the respective tapes 32a and 32b are engaged with each other, whereby the skin member 25 and the skin piece 26 are connected to each other.

Meanwhile, when the slider 32c is moved to the right edge 25e side, the elements 32d are disengaged from each other, whereby the connection between the skin member 25 and the skin piece 26 is undone. When the connection made by using the zipper 32 is undone, the skin piece 26 having previously covered a part of the back surface 21f of the pad 21 is opened about the yarn 33, whereby the previously covered back surface 21f is exposed.

In addition, the skin piece 26 has a reverse surface (a surface on the pad 21 side in the connected state) having an upper part on which a cloth-like reverse surface material 34 is superposed. The reverse surface material 34 has a lower edge and other peripheral edges. The other peripheral edges are sewn to the skin piece 26 by using the yarn 37 together with the tape 32b. Between the reverse surface material 34 and the skin piece 26, a flat-sheet-shaped reinforcement sheet 35 formed of a synthetic resin and having a higher rigidity than the skin piece 26 is sandwiched substantially over the entire surfaces. Both the lower edge of the reverse surface material 34 and a lower edge of the reinforcement sheet 35 are sewn to the skin piece 26 by using a yarn 38.

Since the reinforcement sheet 35 is sandwiched between the reverse surface material 34 and the skin piece 26, the reinforcement sheet 35 can be made less likely to come off the skin piece 26, without having to sew the reinforcement sheet 35 to the skin piece 26 by using the yarn 37. In a case where the reinforcement sheet 35 is sewn to the skin piece 26 by using the yarn 37, portions of the reinforcement sheet 35 other than the lower edge thereof need to be bent so as to be fitted on corners of the pad 21. Unlike in said case, the sandwiching can make it unnecessary to bend the reinforcement sheet 35, whereby the skin piece 26 on which the reinforcement sheet 35 has been superposed can be easily manufactured.

The bolster 20 described above has an upper part formed by covering the pad 21 by a bag portion composed of the skin member 25 and the skin piece 26. Consequently, even when the back surface of the bolster 20 protrudes from the side wall 16 to the car interior side in the leftward-rightward direction as shown in FIG. 2, the pad 21, the bracket 23, and the like can be made less likely to be exposed to the car interior as long as the protrusion is within the range of the provided skin piece 26. Therefore, the shape of the bolster 20 within the range of the provided skin piece 26 does not have to match the shape of the side wall 16 in order to prevent this exposure, whereby the versatility of the bolster 20 can be improved.

Even in a case where the bag portion composed of the skin member 25 and the skin piece 26 is formed, when a connection between the skin piece 26 and the skin member 25 made by using the zipper 32 is undone (a detachable portion is detached), substantially the entirety of the back surface 21f of the pad 21 is exposed. After the pad 21 is covered by the skin member 25 in a state where the connection is undone, the skin piece 26 is connected to the skin member 25, whereby work for attaching the bag portion to the pad 21 can be easily performed.

The constituent with which the skin piece 26 and the skin member 25 are detachably connected to each other is not limited to the zipper 32 and may be, for example, a hook-and-loop fastener, a snap button, or the like. However, in the case of the zipper 32, the connection can be further inhibited from being unintentionally undone than in a case where the skin piece 26 and the skin member 25 are detachably connected to each other by using a hook-and-loop fastener or the like. Therefore, the skin piece 26 having been exposed can be inhibited from sagging by unintentionally undoing the connection.

The skin member 25 is fixed not only to a part, of the back surface 21f of the pad 21, that is present at such a position as not to be covered by the skin piece 26 but also to a part (on the reverse surface side of the skin piece 26), of the back surface 21f of the pad 21, that is present at such a position as to be covered by the skin piece 26. Consequently, it can be made less likely for a wrinkle or the like to be formed on the skin member 25 at a part thereof near the skin piece 26, whereby a beautiful appearance of the skin member 25 can be ensured. Furthermore, by undoing the connection made by using the zipper 32, the skin member 25 can be easily fixed to the pad 21 at a part thereof on the reverse surface side of the skin piece 26.

Parts of the recess 27 and the air bag 24 are each present on the reverse surface side of the skin piece 26. In this case as well, the air bag 24 and the skin piece 26 can be made less likely to interfere with each other by undoing the connection made by using the zipper 32 at the time of assembling the bolster 20 in which the air bag 24 is accommodated in the recess 27. In addition, even though either of the screw shanks 24a for fixing the air bag 24 to the bracket 23, either of the mounting holes 23g through which the wire of the air bag 24 is fixed, and the like are present on the reverse surface side of the skin piece 26, these fixations can be easily performed.

The reinforcement sheet 35 having a higher rigidity than the skin piece 26 is attached to the reverse surface of the skin piece 26 so as to straddle the recess 27. Consequently, the skin piece 26 can be inhibited from being warped toward the recess 27, and a wrinkle can be inhibited from being formed on the skin piece 26, whereby a beautiful appearance of the skin piece 26 exposed to the car interior can be ensured. Furthermore, the reinforcement sheet 35 is provided over substantially the entire surface of the skin piece 26 at a part thereof exposed to the car interior, whereby the skin piece 26 is not significantly warped even when being pressed by an occupant or the like, and a beautiful appearance of the skin piece 26 can be further ensured.

Although the present invention has been described above based on the above embodiment, it can be easily understood that the present invention is not limited to the above embodiment at all, and various modifications and improvements may be made without departing from the gist of the present invention. For example, the shapes, the dimensions, the numbers, and the like of the constituents of the bolster 20 may be changed as appropriate.

In the above embodiment, a case where the armrest 13 is provided on the left side of the seat back 12 and the bolster 20 is provided on the right side of the seat back 12 has been described, but it is not necessarily limited to this case. For example, the vehicle seat 10 may be inverted such that the armrest 13 is provided on the right side of the seat back 12 and the bolster 20 is provided on the left side of the seat back 12. Also, without limitation to a case where the armrest 13 in the accommodated state forms a part of the backrest, the armrest 13 does not have to form a part of the backrest. The car seat 10 is not limited to a back seat of a car and may be a front seat of a car.

Although a case where the skin member 25 is fixed to the bracket 23 via the attachment tool 30 having the shape of a hook, and the skin member 25 is fixed to the pad 21 (frame 22) via the fixation tools 31 which are hog rings, has been described in the above embodiment, the present invention is not necessarily limited to this case. The attachment tool 30 and the fixation tools 31 may each be changed to a bolt, a rivet, a clip, a hog ring, a hook, or the like, and the shape of the corresponding fixation counterpart may be changed accordingly. The skin piece 26 may be extended to such a position that the attachment tool 30 is covered. Also, the skin member 25 may be fixed to the bracket 23 alone or may be fixed to the pad 21 (frame 22) alone. The skin member 25 may be adhered to the pad 21 or may be integrated with the pad 21 by foaming the pad 21 on the inner side of the skin member 25.

Although a case where the skin piece 26 is detachably connected to the upper edge 25c, the left edge 25d, and the right edge 25e of the skin member 25 has been described in the above embodiment, the present invention is not necessarily limited to this case. The skin piece 26 may be sewn to the upper edge 25c, the left edge 25d, and the right edge 25e by using a yarn. Parts of the skin member 25 near these respective edges, and the skin piece 26, may be integrally formed by using the same material.

Without limitation to a case where the skin piece 26 is formed of a carpet material, the skin piece 26 may be formed of a material such as fabric, synthetic leather, or leather other than a carpet material. However, in a case where the skin piece 26 is formed of a carpet material, the tactile quality or the like of the skin piece 26 exposed to the car interior can be enhanced.

Also, without limitation to a case where a part of the skin piece 26 is sewn to the skin member 25 by using the yarn 33, the skin piece 26 may be configured to be detachable from the skin member 25 without using the yarn 33. A configuration may be employed in which the skin piece 26 is sewn to the upper edge 25c of the skin member 25 by using a yarn and is detachably connected to the left edge 25d and the right edge 25e of the skin member 25 such that the back surface 21f of the pad 21 covered by the skin piece 26 can be exposed. Alternatively, a configuration may be employed in which the skin piece 26 is sewn to the left edge 25d of the skin member 25 by using a yarn and is detachably connected to the upper edge 25c and the right edge 25e of the skin member 25 such that the back surface 21f of the pad 21 covered by the skin piece 26 can be exposed.

### DESCRIPTION OF REFERENCE NUMERALS

12 seat back
16 side wall
20 bolster
21 pad
21a front surface
21b upper surface
21d left side surface (one side of both side surfaces)
21e right side surface (the other side of both side surfaces)
21f back surface
22 frame
23 bracket
24 air bag
25 skin member
25c upper edge
25d left edge (one side of both side edges)
25e right edge (the other side of both side edges)
26 skin piece
27 recess
31 fixation tools
32 zipper
35 reinforcement sheet

What is claimed is:

1. A bolster configured to be provided to a side part of a seat back forming a backrest, the bolster being configured to be fixed to a side wall of a car compartment, the bolster comprising:
a pad formed of foam;
a bracket fixed to a back surface of the pad and configured to be attached to the side wall;
a skin member fixed to at least one of the pad and the bracket so as to cover a front surface, an upper surface, and both side surfaces of the pad; and
a skin piece connected to an upper edge and both side edges on a back side of the skin member so as to cover a part of an upper side of the back surface of the pad.

2. The bolster according to claim 1, wherein the skin piece is detachably connected to at least parts of the upper edge and both side edges of the skin member such that the back surface of the pad covered by the skin piece can be exposed.

3. The bolster according to claim 2, wherein the skin piece is detachably connected to the at least parts of the upper edge and both side edges of the skin member by using a zipper.

4. The bolster according to claim 2, wherein the skin member is fixed to a part, of the back surface of the pad or the bracket, that is present at such a position as to be covered by the skin piece.

5. The bolster according to claim 2, further comprising
an air bag attached to the bracket and accommodated in a recess formed in the back surface of the pad, wherein
parts of the recess and the air bag are each present at such a position as to be covered by the skin piece.

6. The bolster according to claim 5, further comprising
a reinforcement sheet having a higher rigidity than the skin piece and attached to a surface on the pad side of the skin piece so as to straddle the recess.

7. The bolster according to claim 1, further comprising
an air bag attached to the bracket and accommodated in a recess formed in the back surface of the pad, wherein
the pad has a frame that is formed of a metal and that is embedded along the back surface of the pad so as to enclose the recess,
the skin member is fixed to the back surface of the pad by being attached to the frame via a plurality of fixation tools that are away from each other, so as to enclose the recess, and
the bracket is a member that is formed of a metal and that is fixed to the back surface of the pad by being attached to the frame so as to straddle the recess.

8. The bolster according to claim 1, wherein the skin piece is formed of a carpet material.
